(19) United States
(12) Patent Application Publication
(10) Pub. No.: US 2015/0042238 A1
(43) Pub. Date: Feb. 12, 2015

(54) DRIVING METHOD OF MULTI-COMMON ELECTRODES AND DISPLAY DEVICE

(71) Applicant: Novatek Microelectronics Corp., Hsinchu (TW)

(72) Inventors: Yun-Chen Chuang, Hsinchu City (TW); Chia-Wei Su, Hsinchu City (TW); Teng-Jui Yu, Taoyuan County (TW); Chu-Ya Hsiao, Hsinchu City (TW)

(73) Assignee: Novatek Microelectronics Corp., Hsinchu (TW)

(21) Appl. No.: 14/028,525

(22) Filed: Sep. 16, 2013

(30) Foreign Application Priority Data
Aug. 12, 2013 (TW) 102128854

(51) Int. Cl. G09G 3/00

(52) U.S. Cl. CPC G09G 3/00
USPC 315/291

(57) ABSTRACT

A driving method of multi-common electrodes and a display device are provided. The driving method includes following steps: providing a plurality of common voltages, in which the common voltages include a first common voltage and a second common voltage, and the first common voltage is different from the second common voltage. During a first period, the first common voltage is set to a first voltage level to drive a first common electrode of a first pixel region in the display panel, and the second common voltage is set to a third voltage level to drive a second common electrode of a second pixel region in the display panel. During a second period, the first common voltage is set to a second voltage level to drive the first common electrode, and the second common voltage is set to a fourth voltage level to drive the second common electrode.

### CROSS-REFERENCE TO RELATED APPLICATION

This application claims the priority benefit of Taiwan application serial no. 102128854, filed on Aug. 12, 2013. The entirety of the above-mentioned patent application is hereby incorporated by reference herein and made a part of this specification.

### FIELD OF THE INVENTION

The invention relates generally to an electronic device, and more particularly to a display device and a driving method of multi-common electrodes.

### RELATED ART

The rapid development of the multimedia society mostly benefits from the tremendous progress in semiconductor devices or display devices. For displays, liquid crystal displays (LCDs) having advantages such as good display quality, preferable space utilization, low power consumption, and no radiation have gradually become the main stream in the market.

It should be noted that, the driving framework of the current LCDs may be divided into two types. One type adopts a driving framework of direct current (DC) mode common voltage (e.g., dot inversion driving methods), which is typically used to drive the larger sized LCD panels. Another type adopts a driving framework of alternate current (AC) mode common voltage (e.g. line inversion driving methods), which is typically used to drive the medium and smaller sized LCD panels.

However, when the driving framework of the DC mode common voltage is adopted to drive larger sized LCD panels, even though a preferable image display effect may be achieved, the power consumption of the entire LCD also increases accordingly. Moreover, when the driving framework of the AC mode common voltage is adopted to drive the medium and smaller sized LCD panels, although the power consumption of the entire LCD may be reduced, flicker and residual image phenomena may result on the LCD due to the entire panel having the same polarity within a certain time period, which greatly impacts the display quality of the LCD.

### SUMMARY OF THE INVENTION

The invention provides a driving method of multi-common electrodes and a display device, capable of using multiple sets of common voltage interlacing and switching techniques each driving different common electrodes on the display panel to achieve low power consumption and preferable image display.

The invention provides a driving method of multi-common electrodes adapted for driving a display panel, comprising the following steps. Pluralities of common voltages are provided, in which the common voltages include a first common voltage and a second common voltage, and the first common voltage is different from the second common voltage. During a first period, the first common voltage is set to a first voltage level to drive a first common electrode of a first pixel region in the display panel, and the second common voltage is set to a third voltage level to drive a second common electrode of a second pixel region in the display panel. During a second period, the first common voltage is set to a second voltage level to drive the first common electrode, and the second common voltage is set to a fourth voltage level to drive the second common electrode.

The invention provides a display device, including a display panel, a display driving circuit, and a common electrode driving circuit. The display panel includes a plurality of common electrodes. The common electrodes include a first common electrode and a second common electrode. The first common electrode is distributed in a first pixel region in the display panel, and the second common electrode is distributed in a second pixel region in the display panel. The first common electrode and the second common electrode are not connected to each other. The display driving circuit is coupled to at least one data line and at least one scan line in the display panel. The common electrode driving circuit is coupled to the common electrodes of the display panel. During a first period, the common electrode driving circuit sets a first common voltage to a first voltage level to drive the first common electrode, and during a second period, the common electrode driving circuit sets the first common voltage to a second voltage level to drive the first common electrode. Moreover, during the first period, the common electrode driving circuit sets a second common voltage to a third voltage level to drive the second common electrode, and during the second period, the common electrode driving circuit sets the second common voltage to a fourth voltage level to drive the second common electrode.

According to an embodiment of the invention, the driving method further includes the following steps. A third common voltage is provided, and during the first period, the third common voltage is set to a fifth voltage level to drive a third common electrode of a third pixel region in the display panel. Moreover, during the second period, the third common voltage is set to a sixth voltage level to drive the third common electrode.

According to an embodiment of the invention, the first pixel region and the second pixel region in the driving method are determined according to the different types of polarity distribution on the display panel.

According to an embodiment of the invention, the driving method further comprises performing charge sharing to the first common electrode and the second common electrode before changing the voltages of the first common electrode and the second common electrode.

According to an embodiment of the invention, the first period and the second period in the driving method respectively include one or more frame lengths.

According to an embodiment of the invention, the common electrode driving circuit further includes a voltage generator and an interlacing device. The voltage generator provides the first voltage level, the second voltage level, the third voltage level, and the fourth voltage level. The interlacing device is coupled between the voltage generator and the common electrodes. During the first period, the interlacing device respectively transmits the first voltage level and the third voltage level provided by the voltage generator to the first common electrode and the second common electrode. Moreover, during the second period, the interlacing device respectively transmits the second voltage level and the fourth voltage level provided by the voltage Generator to the first common electrode and the second common electrode.

According to an embodiment of the invention, the voltage generator further provides a third common voltage. During the first period, the interlacing device sets the third common voltage to a fifth voltage level to drive a third common electrode of a third pixel region in the display panel. Moreover, during the second period, the interlacing device sets the third common voltage to a sixth voltage level to drive the third common electrode.

According to an embodiment of the invention, the first pixel region and the second pixel region are determined according to the different types of polarity distribution on the display panel.

According to an embodiment of the invention, the common electrode driving circuit further includes a charge sharing switch having a first end coupled to the first common electrode, and a second end coupled to the second common electrode. Before changing the voltages of the first common electrode and the second common electrode, the charge sharing switch performs charge sharing to the first common electrode and the second common electrode.

According to an embodiment of the invention, the first period and the second period respectively include one or more frame lengths.

In summary, according to the driving methods of multi-common electrodes and display devices in the embodiments of the invention, a plurality of common electrodes on the display panel can be driven by inputting multiple sets of common voltage interlacing and switching techniques in the common electrode driving circuit of the display device. Accordingly, besides achieving the effect of reducing power consumption, phenomena such as flicker or residual image in the display effect due to the same polarity on the display panel can be prevented, thereby effectively enhancing the display quality of the display device.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a display device according to an embodiment of the invention.

FIG. 2 is a schematic block diagram of the common electrode driving circuit shown in FIG. 1 according to an embodiment of the invention.

FIG. 3 is a schematic view of the timing relationship between the common voltages VCOM1 and VCOM2 shown in FIG. 1 during the first period and the second period according to an embodiment of the invention.

FIG. 4A is a schematic view of a polarity distribution of the pixel regions on the display panel shown in FIG. 1 during the first period according to a first embodiment of the invention.

FIG. 4B is a schematic view of a polarity distribution of the pixel regions on the display panel shown in FIG. 1 during the second period according to the first embodiment of the invention.

FIG. 5 is a schematic view of a polarity distribution of the pixel regions on a display panel according to a second embodiment of the invention.

FIG. 6 is a schematic view of a common electrode polarity distribution of the pixel regions on a display panel according to a third embodiment of the invention.

FIG. 7 is a schematic view of a common electrode polarity distribution of the pixel regions on a display panel according to a fourth embodiment of the invention.

FIG. 8 is a schematic view of the charge sharing performed on the common voltages VCOM1 and VCOM2 of FIG. 2 between the first period and the second period according to an embodiment of the invention.

### DESCRIPTION OF EMBODIMENTS

Descriptions of the invention are given with reference to the exemplary embodiments illustrated with accompanied drawings, in which same or similar parts are denoted with same reference numerals. Moreover, when possible, elements/components/notations with same reference numerals represent same or similar parts in the drawings and embodiments.

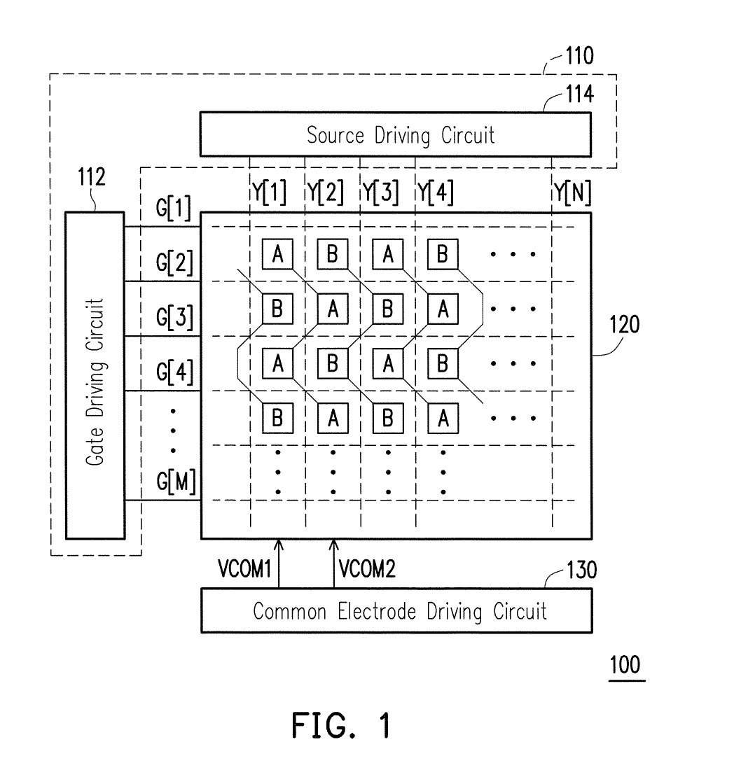

FIG. 1 is a schematic block diagram of a display device according to an embodiment of the invention. With reference to FIG. 1, according to the present embodiment, a display device 100 includes a display driving circuit 110, a display panel 120, and a common electrode driving circuit 130. The display panel 120 includes a plurality of scan lines G[1], G[2], G[3], G[4], . . . , G[M], and a plurality of data lines Y[1], Y[2], Y[3], Y[4], . . . , Y[N]. The display driving circuit 110 is coupled to the data lines Y[1]-Y[N] and the scan lines G[1]-G[M] in the display panel 120. The display driving circuit 110 may include a gate driving circuit 112 and a source driving circuit 114, although the invention is not limited thereto. When the display driving circuit 110 receives an image signal (not drawn), the gate driving circuit 112 may output a scan voltage to the scan lines G[1]-G[M] on the display panel 120, and the source driving circuit 114 may concurrently output a corresponding drive voltage of the image signal to drive the data lines Y[1]-Y[N] on the display panel 120. Accordingly, by simultaneous operation of the gate driving circuit 112 and the source driving circuit 114, the display driving circuit 110 may effectively write the display data (image signal) in the different pixels on the display panel 120, such that the display panel 120 displays the corresponding image content.

The display panel 120 further includes a plurality of common electrodes. The common electrode driving circuit 130 is coupled to the common electrodes of the display panel 120. Using FIG. 1 as an example, the common electrodes include a common electrode A and a common electrode B. The common electrode A is distributed in a first pixel region of the display panel 120, and the common electrode B is distributed in a second pixel region of the display panel 120. The common electrode A and the common electrode B are not connected to each other. Moreover, in the present embodiment, the layout methods of the first pixel region and the second pixel region respectively corresponding to the common electrodes A and B may be determined according to the different types of polarity distribution on the display panel 120. For example, the layout methods of the common electrodes A and B may be determined by polarity distribution requirements such as row inversion, column inversion, single dot inversion, multiple dot inversion, M+N dot inversion, or frame inversion. In the present embodiment, the layout methods of the common electrodes A and B in the display panel 120 may be as shown in FIG. 1. The common electrodes A and B respectively receive different common voltages provided by the common electrode driving circuit 130, such as common voltages VCOM1 and VCOM2. Accordingly, the display panel 120 may implement a polarity distribution of dot inversion.

On the other hand, the common electrode driving circuit 130 provides a plurality of common voltages, such as VCOM1 and VCOM2, to the common electrodes of the corresponding pixel regions on the display panel 120. In the present embodiment, the common voltages VCOM1 and VCOM2 provided by the common electrode driving circuit 130 are common voltages having an AC voltage swing (described later in FIG. 3). In the present embodiment, for clarity of the illustration, only the common voltages VCOM1 and VCOM2 and the common electrodes A and B are drawn in FIG. 1, although other embodiments are not limited thereto. During a first period, the common electrode driving circuit 130 may set the common voltage VCOM1 to a first voltage level V1 to drive the common electrode A of the display panel 120. Moreover, during a second period, the common electrode driving circuit 130 may set the common voltage VCOM1 to a second voltage level V2 to drive the common electrode A of the display panel 120. Similarly, during the first period, the common electrode driving circuit 130 may set the common voltage VCOM2 to a third voltage level V3 to drive the common electrode B of the display panel 120. Furthermore, during the second period, the common electrode driving circuit 130 may set the common voltage VCOM2 to a fourth voltage level V4 to drive the common electrode B of the display panel 120.

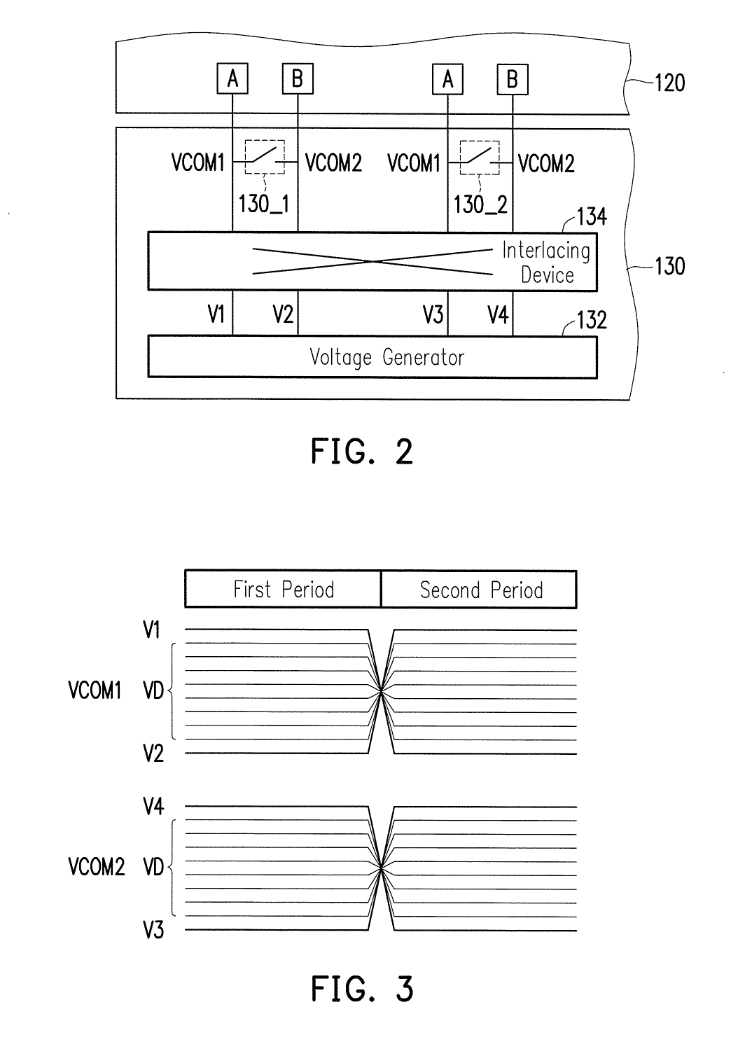

However, the present embodiment does not limit the implementation of the common electrode driving circuit 130. For example, in some embodiments, the common electrode driving circuit 130 may be implemented by a digital to analog converter (DAC), a voltage regulator, or by other types of circuits. As an another example, FIG. 2 is a schematic block diagram of the common electrode driving circuit 130 shown in FIG. 1 according to an embodiment of the invention. With reference to FIG. 2, the common electrode driving circuit 130 includes a voltage generating circuit 132 and an interlacing device 134. The voltage generating circuit 132 generates a plurality of voltage levels. Using FIG. 2 as an example, the voltage generating circuit 132 provides four voltage levels V1, V2, V3, and V4. In some embodiments, the voltage levels V1, V2, V3, and V4 may be four voltage levels that are different from each other. In other embodiments, the voltage level V1 may be the same as the voltage level V4, and the voltage level V2 may be the same as the voltage level V3.

During the first period, the interlacing device 134 may transmit the voltage level V1 provided by the voltage generating circuit 132 to the common electrode A of the display panel 120 to serve as the common voltage VCOM1. Moreover, during the first period, the interlacing device 134 may transmit the voltage level V3 provided by the voltage generating circuit 132 to the common electrode B of the display panel 120 to serve as the common voltage VCOM2. Thereafter, during the second period, the interlacing device 134 may transmit the voltage level V2 provided by the voltage generating circuit 132 to the common electrode A of the display panel 120 to serve as the common voltage VCOM1. Furthermore, during the second period, the interlacing device 134 may transmit the voltage level V4 provided by the voltage generating circuit 132 to the common electrode B of the display panel 120 to serve as the common voltage VCOM2.

In order to better describe the driving method of multi-common electrodes in detail, further elaboration of the exemplary embodiments are provided with reference to the accompanied drawings hereafter.

FIG. 3 is a schematic view of the timing relationship between the common voltages VCOM1 and VCOM2 shown in FIG. 1 during the first period and the second period according to an embodiment of the invention. A voltage level VD in FIG. 3 represents a range of data voltage levels transmitted by the data lines Y[1]-Y[N] in the display panel 120 shown in FIG. 1. With reference to FIGS. 1 and 3, the common electrode driving circuit 130 respectively provides a plurality of common voltages VCOM1 and VCOM2 to different common electrodes A and B of the display panel 120, and the common voltages VCOM1 and VCOM2 are different from each other. As shown in FIG. 3, a driving period of the common electrode driving circuit 130 may be at least divided into the first period and the second period in sequence. The first period and the second period respectively include one or more frame lengths. For example, the first period may be the nth frame period, and the second period may the n+1 frame period.

During the first period depicted in FIG. 3, the common electrode driving circuit 130 may set the common voltage VCOM1 to the voltage level V1 to drive a common electrode (e.g. common electrode A) in the display panel 120, and set the common voltage VCOM2 to the voltage level V3 to drive another common electrode (e.g. common electrode B) in the display panel 120. During the second period after the first period, the common electrode driving circuit 130 may set the common voltage VCOM1 to the voltage level V2 to drive a common electrode (e.g. common electrode A) in the display panel 120, and set the common voltage VCOM2 to the voltage level V4 to drive another common electrode (e.g. common electrode B) in the display panel 120.

Alternatively, in other embodiments, during the first period shown in FIG. 3, the common electrode driving circuit 130 may set the common voltage VCOM1 to the voltage level V2, and set the common voltage VCOM2 to the voltage level V4. During the second period after the first period, the common electrode driving circuit 130 may change the common voltage VCOM1 to the voltage level V1, and change the common voltage VCOM2 to the voltage level V3.

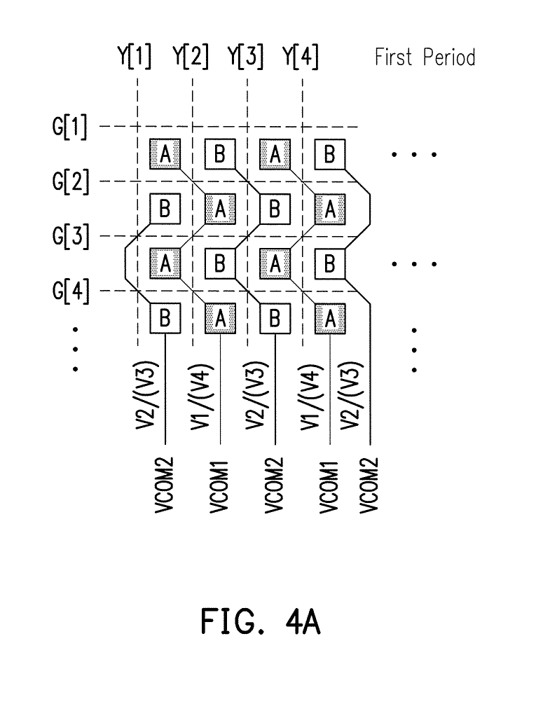

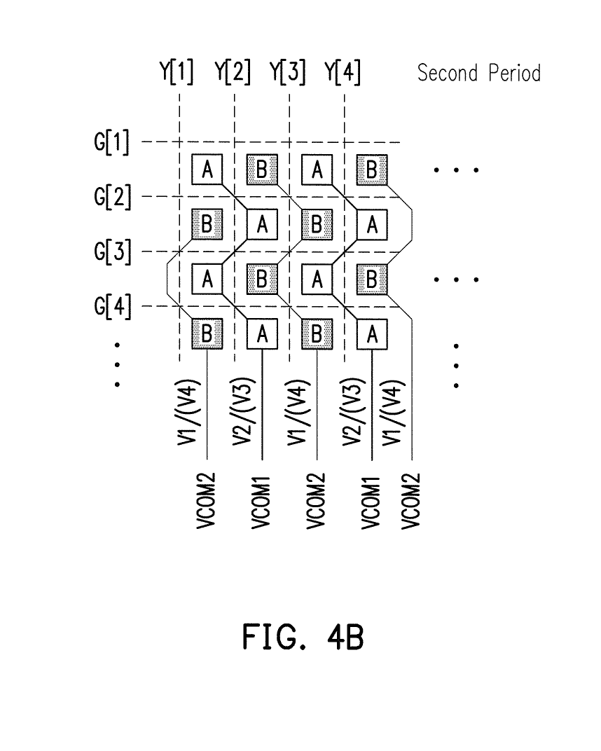

FIGS. 4A and 4B are schematic views of the polarity distributions of the pixel regions on the display panel 120 shown in FIG. 1 according to a first embodiment of the invention. In the embodiment illustrated by FIGS. 4A and 4B, assume the voltage level V1 depicted in FIG. 3 is the same as the voltage level V4, and the voltage level V2 is the same as the voltage level V3. With reference to FIGS. 3 and 4A, the display panel 120 is divided into different common electrodes A and B according to the different pixel regions, and each of the common electrodes A and B are respectively coupled to the corresponding common voltage VCOM1 and VCOM2.

During the first period shown in FIG. 3, the common electrode driving circuit 130 may set the common voltage VCOM1 to the voltage level V1, such that the pixels where the common electrodes A are located in the display panel 120 are operated at a negative polarity. During the same first period, the common electrode driving circuit 130 may set the common voltage VCOM2 to the voltage level V3 (e.g., V3 is equal to V2 in the present embodiment), such that the pixels where the common electrodes B are located in the display panel 120 are operated at a positive polarity. Thereafter, with reference to FIGS. 3 and 4B, during the second period after the first period, the common electrode driving circuit 130 may set the common voltage VCOM1 to the voltage level V2, such that the pixels where the common electrodes A are located in the display panel 120 are operated at the positive polarity. During the same second period, the common electrode driving circuit 130 may set the common voltage VCOM2 to the voltage level V4 (e.g., V4 is equal to V1 in the present embodiment), such that the pixels where the common electrodes B are located in the display panel 120 are operated at the negative polarity. In the present embodiment, during the first period and the second period, the pixel regions on the display panel in gray blocks represent negative polarity, while the white blocks represent positive polarity, as shown in FIGS. 4A and 4B.

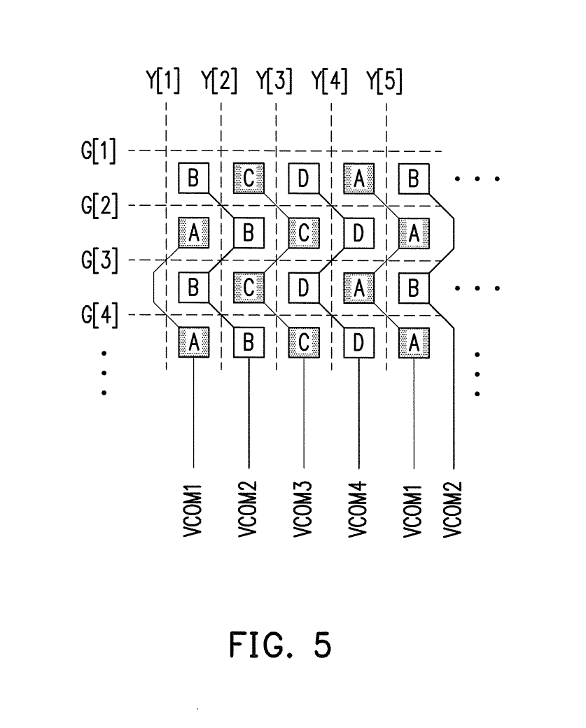

FIG. 5 is a schematic view of a common electrode polarity distribution of the pixel regions on a display panel according to a second embodiment of the invention. The embodiment shown in FIG. 5 may be inferred with reference to the related descriptions of FIG. 1, FIG. 4A, and/or FIG. 4B. FIG. 5 is different from FIGS. 4A and 4B in that, the embodiment shown in FIG. 5 adopts four common voltages VCOM1, VCOM2, VCOM3, and VCOM4, and common electrodes A, B, C, and D are configured in the corresponding pixel regions on the display panel. The common electrodes A, B, C, and D on the display panel are not connected to each other. A common electrode driving circuit may respectively provide the common voltages VCOM1, VCOM2, VCOM3, and VCOM4 to the common electrodes A, B, C, and D.

In some embodiments, the common voltages VCOM1, VCOM2, VCOM3, and VCOM4 may be different from each other. For example, during the first period, the common electrode driving circuit may respectively set the common electrodes A, B, C, and D to a first voltage level, a third voltage level, a fifth voltage level, and a seventh voltage level, so as to respectively drive the common electrode A of a first pixel region, the common electrode B of a second pixel region, the common electrode C of a third pixel region, and the common electrode D of a fourth pixel region. During the second period, the common electrode driving circuit may respectively set the common electrodes A, B, C, and D to a second voltage level, a fourth voltage level, a sixth voltage level, and an eighth voltage level, so as to respectively drive the common electrode A of the first pixel region, the common electrode B of the second pixel region, the common electrode C of the third pixel region, and the common electrode D of the fourth pixel region. The driving methods of the common electrodes A, B, C, and D may be inferred by reference to the related descriptions of FIGS. 4A and 4B, and therefore further elaboration thereof is omitted hereafter.

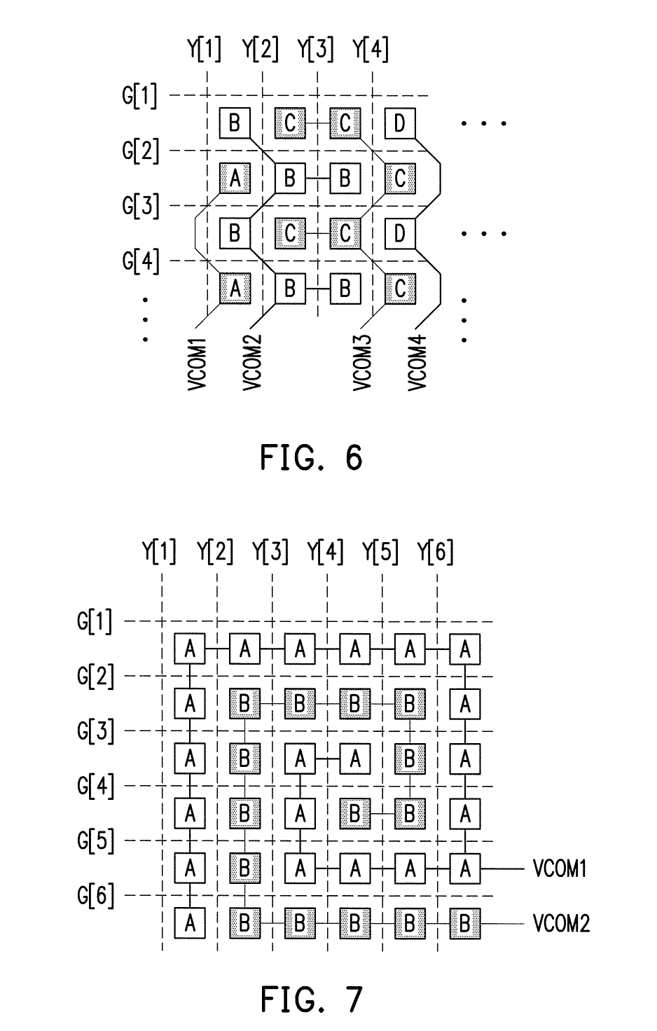

FIG. 6 is a schematic view of a common polarity distribution of the pixel regions on a display panel according to a third embodiment of the invention. The embodiment shown in FIG. 6 may be inferred with reference to the related descriptions of FIG. 1, FIG. 4A, FIG. 4B, and/or FIG. 5. FIG. 6 is different from FIG. 5 in that, the embodiment depicted in FIG. 6 has a different distribution of the common electrodes on the display panel compared to the distribution of the common electrodes on the display panel shown in FIG. 5.

FIG. 7 is a schematic view of a common electrode polarity distribution of the pixel regions on a display panel according to a fourth embodiment of the invention. The embodiment shown in FIG. 7 may be inferred with reference to the related descriptions of FIG. 1, FIG. 4A, and/or FIG. 4B. FIG. 7 is different from FIGS. 4A and 4B in that, the embodiment depicted in FIG. 7 has a different distribution of the common electrodes on the display panel compared to the distribution of the common electrodes on the display panel shown in FIGS. 4A and 4B.

With reference to FIG. 2, in another embodiment, the common electrode driving circuit 130 may be further selectively configured with the charge charging switches 136_1 and 136_2. Using the charge sharing switch 136_1 depicted in FIG. 2 as an example, a first end of the charge sharing switch 136_1 is coupled to the common electrode A on the display panel 120, and a second end of the charge sharing switch 136_1 is coupled to the other common electrode B on the display panel 120. It should be noted that, before changing the voltage levels of the common electrode A and the other common electrode B in the display panel 120, the charge sharing switch 136_1 may be temporarily turned on to perform charge sharing to the common electrode A and the other common electrode B, and thereby reducing the power consumption of the common electrode driving circuit 130. Besides the charge sharing period, the charge sharing switches 136_1 and 136_2 are both maintained at cut off.

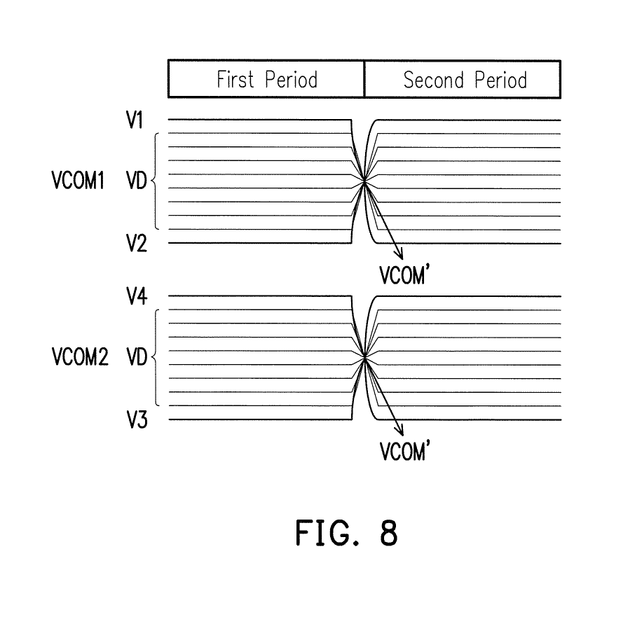

FIG. 8 is a schematic view of the charge sharing performed on the common voltages VCOM1 and VCOM2 of FIG. 2 between the first period and the second period according to an embodiment of the invention. The voltage level VD in FIG. 8 represents a range of data voltage levels transmitted by the data lines in the display panel 120. The embodiment shown in FIG. 8 may be inferred with reference to the related description of FIG. 3. With reference to FIGS. 2 and 8, since the common electrode driving circuit 130 further includes a plurality of charge sharing switches 136_1 and 136_2, therefore, before the common electrode driving circuit 130 changes the voltage levels of the common voltages VCOM1 and VCOM2, the common electrode driving circuit 130 controls the on/off state of the charge sharing switches 136_1 and 136_2, so that the charge sharing switches 136_1 and 136_2 are temporarily turned on. After charge sharing is completed, the charge sharing switches 136_1 and 136_2 are both maintained at cut off. According, charge sharing may be performed between each common electrode A and common electrode B.

Using the common voltages VCOM1 and VCOM2 in FIG. 8 as an example, during the first period, the display device sets the common voltage VCOM1 to the voltage level V1 for inputting to the common electrode A on the display panel 120. Moreover, the display device sets the common voltage VCOM2 to the voltage level V3 for inputting to the common electrode A on the display panel 120. When the first period switches to the second period, which is before the interlacing device 134 in the common electrode driving circuit 130 switches the voltage levels of the common voltages VCOM1 and VCOM2 from V1 and V3 to V2 and V4, the charge sharing switches 136_1 and 136_2 temporarily turns on. Accordingly, the voltage levels of the common voltages VCOM1 and VCOM2 converge close to an average value VCOM′ of the voltage levels V1 and V3 due to a short circuit, and thereby charge sharing is performed. After charge sharing is completed, the charge sharing switch 136_1 is cut off again, such that during the second period, the common electrode driving circuit 130 may continually charge/discharge the voltage levels of the common voltages VCOM1 and VCOM2 from the voltage level VCOM′ to the voltage levels V2 and V4. Therefore, compared to the embodiment shown in FIG. 3, the power consumption of the common electrode driving circuit 130 of the embodiment depicted in FIG. 8 can be reduced.

In view of the foregoing, according to the driving methods of multi-common electrodes and display devices in the embodiments of the invention, a plurality of common electrodes on the display panel can be driven in sequence during different periods by inputting multiple sets of common voltage interlacing and switching techniques in the common electrode driving circuit of the display device, while adopting charge sharing mechanisms to increase the speed of the voltage level transitions. Accordingly, besides achieving the effect of reducing power consumption, the display device adopting the aforementioned driving method does not generate residual image issues. Moreover, transient responses with the same polarity for the entire panel which causes issues such as image flicker would not be generated, thereby effectively enhancing the display quality of the display device.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A driving method of multi-common electrodes, adapted for driving a display panel, the method comprising:
providing a plurality of common voltages, wherein the common voltages comprise a first common voltage and a second common voltage, wherein the first common voltage is different from the second common voltage;
during a first period, setting the first common voltage to a first voltage level to drive a first common electrode of a first pixel region in the display panel;
during a second period, setting the first common voltage to a second voltage level to drive the first common electrode;
during the first period, setting the second common voltage to a third voltage level to drive a second common electrode of a second pixel region in the display panel; and
during the second period, setting the second common voltage to a fourth voltage level to drive the second common electrode.

2. The driving method of multi-common electrodes according to claim 1, further comprising:
providing a third common voltage;
during the first period, setting the third common voltage to a fifth voltage level to drive a third common electrode of a third pixel region in the display panel; and
during the second period, setting the third common voltage to a sixth voltage level to drive the third common electrode.

3. The driving method of multi-common electrodes according to claim 1, wherein the first pixel region and the second pixel region are determined according to the different types of polarity distribution on the display panel.

4. The driving method of multi-common electrodes according to claim 1, further comprising:
before changing the voltages of the first common electrode and the second common electrode, performing charge sharing to the first common electrode and the second common electrode.

5. The driving method of multi-common electrodes according to claim 1, wherein the first period and the second period respectively comprise one or more frame lengths.

6. A display device, comprising:
a display panel comprising a plurality of common electrodes, the common electrodes comprising a first common electrode and a second common electrode, the first common electrode is distributed in a first pixel region in the display panel, and the second common electrode is distributed in a second pixel region in the display panel, wherein the first common electrode and the second common electrode are not connected to each other;
a display driving circuit coupled to at least one data line and at least one scan line in the display panel; and
a common electrode driving circuit coupled to the common electrodes of the display panel, wherein during a first period, the common electrode driving circuit sets a first common voltage to a first voltage level to drive the first common electrode, and during a second period, the common electrode driving circuit sets the first common voltage to a second voltage level to drive the first common electrode; and during the first period, the common electrode driving circuit sets a second common voltage to a third voltage level to drive the second common electrode, and during the second period, the common electrode driving circuit sets the second common voltage to a fourth voltage level to drive the second common electrode.

7. The display device according to claim 6, wherein the common electrode driving circuit comprises:
a voltage generator providing the first voltage level, the second voltage level, the third voltage level, and the fourth voltage level; and
an interlacing device coupled between the voltage generator and the common electrodes, wherein during the first period, the interlacing device respectively transmits the first voltage level and the third voltage level provided by the voltage generator to the first common electrode and the second common electrode, and during the second period, the interlacing device respectively transmits the second voltage level and the fourth voltage level provided by the voltage generator to the first common electrode and the second common electrode.

8. The display device according to claim 7, wherein the voltage generator further provides a third common voltage, and during the first period, the interlacing device sets the third common voltage to a fifth voltage level to drive a third common electrode of a third pixel region on the display panel, and during the second period, the interlacing device sets the third common voltage to a sixth voltage level to drive the third common electrode.

9. The display device according to claim 6, wherein the first pixel region and the second pixel region are determined according to the different types of polarity distribution on the display panel.

10. The display device according to claim 6, wherein the common electrode driving circuit further comprises:
a charge sharing switch having a first end coupled to the first common electrode, and a second end coupled to the second common electrode, wherein before changing the voltages of the first common electrode and the second common electrode, the charge sharing switch performs charge sharing to the first common electrode and the second common electrode.

11. The display device according to claim 6, wherein the first period and the second period respectively comprise one or more frame lengths.
